(19) United States
(12) Patent Application Publication
(10) Pub. No.: US 2013/0037473 A1
(43) Pub. Date: Feb. 14, 2013

(54) Fuel Filter Support Structure

(71) Applicants: Matthew Austin Conques, Scott, LA (US); Kenneth James Conques, Scott, LA (US)

(72) Inventors: Matthew Austin Conques, Scott, LA (US); Kenneth James Conques, Scott, LA (US)

(21) Appl. No.: 13/565,747

(22) Filed: Aug. 2, 2012

(51) Int. Cl. B01D 35/30

(52) U.S. Cl. 210/232

(57) ABSTRACT

A fuel filter support structure, particularly suited for use in conjunction with turbine engines, has a base portion, two spaced apart walls extending outwardly from the base portion, and a catch pan underlying the two walls. Two separate banks of fuel filters can be mounted on the walls, and positioned over the catch pan. The catch pan catches any fuel, etc. which may escape during the process of changing the fuel filters, and funnels same toward a central opening where it can be caught in a container. A fuel catch tank is preferably incorporated into the structure.

### BACKGROUND

Internal combustion engines require a clean (relatively solids free) fuel source, whether they be gasoline or diesel engines. As is well known in the relevant industry, particulate matter in fuels can give rise to a number of operational issues, including but not limited to clogging of fuel lines and injectors, etc. In addition, water or other contaminants can cause serious problems.

While efforts are made to maintain fuel sources as contaminant-free as possible, most engines utilize a fuel filter system in line between the fuel source, namely the fuel tank, and engine intake. Some engines use a system of multiple banks of filters arranged in series, with fuel flowing first through a relatively coarser filter, then through relatively finer filters.

Issues arise related to placement of multiple banks of filters, in that space is often confined. It is desirable to place the filters relatively close to the engine intake, yet in a relatively protected area, to have the filter banks well supported, and where possible to have a fuel filter bank support structure that is capable of multiple purposes.

### SUMMARY OF THE INVENTION

The present invention comprises a fuel filter support structure, especially adapted for mounting on or in association with a turbine or other internal combustion engine, having a base portion attachable to the turbine or to associated structure; two spaced apart walls attached to the base and extending outwardly from the base; a means for mounting a plurality of fuel filters on each of said walls, with said fuel filters accessible from a position to either side of said walls; and a catch pan positioned beneath the fuel filters, the catch pan having surface contoured to drain any liquids therein to a central point, and an opening at said central point for draining liquids from the catch pan. The fuel filter support structure enables mounting of at least two banks of fuel filters on or in close proximity to an engine, particularly a turbine, where space is limited, yet the filters need to be accessible for changing. Further, the fuel filter support structure enables any spilled fuel to be readily retained in the catch pan and drained off into a container for disposal. A central space between the two walls provides space for mounting of associated fuel supply equipment, for example hoses or other conduits, possibly valves, fuel pump, etc. Preferably, a forward plate is provided which enables easy mounting of one or more engine monitoring devices, for example gauges and the like. A fuel catch tank may be incorporated into the structure, to provide a receptacle for fuel drained from the engine, during startup/shutdown procedures. From the catch tank, the fuel can be drained to the catch pan.

### BRIEF DESCRIPTION OF THE DRAWINGS

FIGS. 1 and 2 are perspective views of the fuel filter support structure, from a position in front of and above the structure, FIG. 1 showing the structure without fuel filters in place, FIG. 2 showing the structure with banks of fuel filters on either wall.

FIG. 3 is another view of the fuel filter support structure, generally from a position in front of the structure when same is in a typical mounted position.

FIGS. 4 and 5 are top and side views of the structure, respectively.

FIG. 6 is a side view of the structure in place proximal an engine, for illustrative purposes only a turbine.

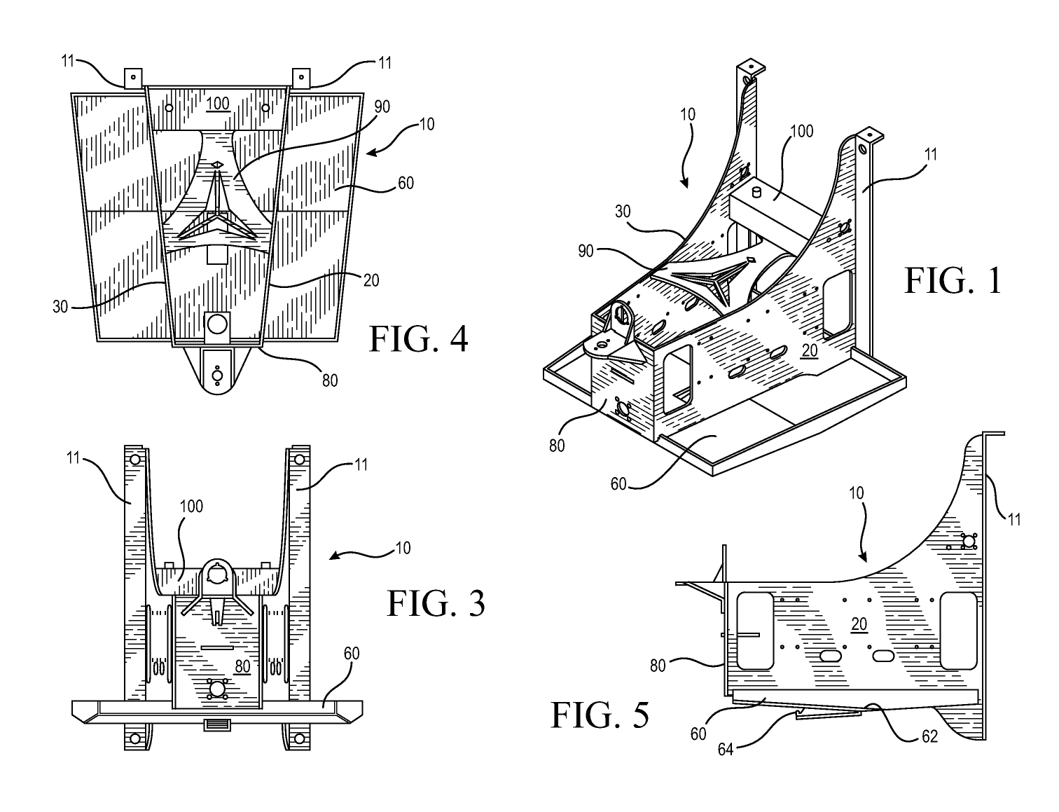

### DESCRIPTION OF THE PRESENTLY PREFERRED EMBODIMENT(S)

While the present invention may comprise a number of different embodiments to enable its its use in different applications, in conjunction with the drawings some of the presently preferred embodiments can be described. It is understood that many variations are possible within the scope of the invention.

Fuel filter support structure 10 comprises a base portion 11 adapted to be connected to an engine, for example a turbine, or to structure associated with the turbine, for example an angle iron framework. In either case, base portion 11 and consequently fuel filter support structure 10 are positioned in an operative position with respect to the engine. Two spaced apart walls 20 and 30 extend are attached to base portion 11 and extend outwardly from base portion 11 and from the turbine. Preferably, walls 20 and 30 angle toward one another in a direction away from the turbine; this in turn keeps fuel filter banks 40 and 50, mounted on walls 20 and 30 respectively, somewhat shielded yet still accessible.

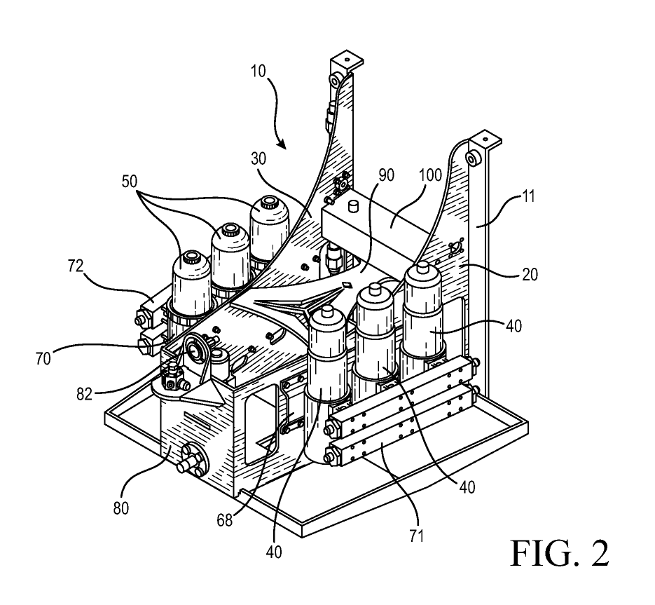

A means for mounting a plurality of fuel filters on each of walls is provided. This means for mounting a plurality of fuel filters may comprise brackets 68 and 70, along with associated receptacles and piping, preferably a manifold fluidly connecting the two banks, preferably in series flow. Portions of the manifold are seen as elements 71, 72 as seen in FIG. 2. Other means of mounting fuel filters may be acceptable. As can be seen from the drawings, the fuel filters in fuel filter banks 40 and 50 are accessible from each side of the support structure.

Periodically, the fuel filters must be changed. As is known in the art, in connection with changing the filters some amount of fuel frequently escapes, dripping or flowing downward from the filters; for safety and environmental purposes, it is important that any such fuel be contained. In order to catch any escaping fuel, the invention comprises a catch pan 60 generally positioned beneath fuel filter banks 40 and 50, catch pan 60 preferably having surface contoured to drain any fuel or other liquids falling in to it to a central point, for example collection point 62, and an opening 64 at said central point for draining liquids from the catch pan. FIG. 5 in particular shows the sloping surfaces of catch pan 60, sloping toward a center location at collection point 62. It is understood that collection point 62 can be at any location on catch pan 60, not necessarily at a center location, but could be for example at one end; it is only important that the surface of catch pan 60 be contoured so that any liquids falling therein tend to drain toward a single point somewhere in catch pan 60, for collection thereof by draining through opening 64.

Fuel filter support structure 10 further preferably comprises additional structural attributes which increase its utility. As can be seen by the drawings, walls 20 and 30 are spaced sufficiently far apart for associated auxiliary fuel supply equipment, for example hoses, etc. to be positioned between the walls. Further, a front plate 80 may be provided in order to both provide structural support for walls 20 and 30 and to provide a mount for engine condition monitoring devices 82, for example pressure gauges, fuel hose/piping connections, etc.

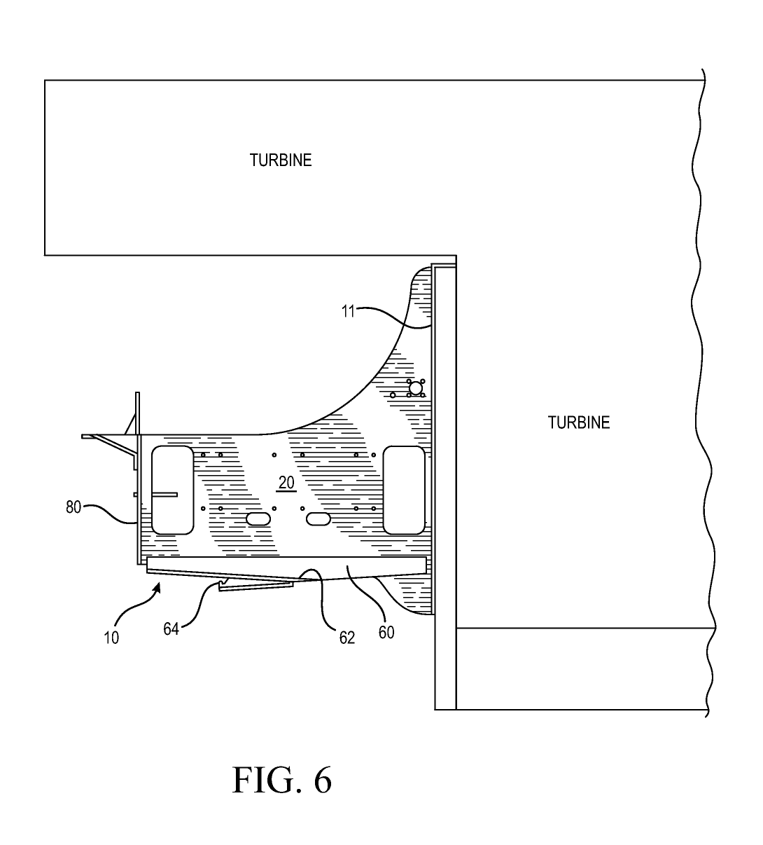

While the fuel filter support structure can be made in various dimensions to suit particular settings, exemplary dimensions include walls 20 and 30 extending outwardly from base portion approximately 39″; walls 20 and 30 spaced apart approximately 26″ nearest the base portion, tapering to about 12″ apart at their other end; walls 20 and 30 being approximately 43″ tall at their tallest point; and catch pan 60 extending outwardly on either side of walls 20 and 30 by approximately 8-12″. FIG. 6 shows an example setting for placement of fuel filter support structure 10, proximal a turbine. It can be seen that fuel filter support structure 10 can be sized and shaped to be positioned in a convenient location with respect to the turbine. It is to be understood that the setting in FIG. 6 is for illustrative purposes only, and other placements in connection with other engines are possible.

Additional structural members for bracing may be used. For example, a top plate 90 may be used to provide additional bracing of walls 20 and 30. Further, a fuel catch tank 100 may be incorporated into fuel filter support structure 10, positioned as shown in the drawings or in another location. The fuel catch tank provides a receptacle for fuel to be received from the engine during certain startup/shutdown procedures; from catch tank 100, fuel can be drained into catch pan 60, if desired.

Fuel filter support structure 10 can be fabricated out of steel, aluminum or other metals, in sheet or other shaped form, by welding, bolting or other suitable means of fastening, as appropriate and as well known in the relevant art. Other materials may be used for at least some parts of the structure, including but not limited to non-metal composites, etc. One presently preferred embodiment uses plate aluminum in 3/16″ to ⅜″ thicknesses, as appropriate.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example:
dimensions and specific shapes of the various components, and of the fuel filter support structure overall, may be varied to suit particular applications;
different materials may be used;
the fuel filter support structure may be used in conjunction with different types of engines.

Therefore, the scope of the invention is to be determined not by the illustrative examples set forth above, but by the appended claims and their legal equivalents.

I claim:

1. A fuel filter support structure especially adapted for mounting in a confined area proximal an engine, comprising:
a base portion adapted to be mounted in a operative position with respect to said engine;
two spaced apart walls attached to the base portion and extending outwardly therefrom; and
means for mounting a plurality of fuel filters on each of said walls, with said fuel filters accessible from a position to either side of said walls.

2. The fuel filter support structure of claim 1, further comprising a catch pan positioned beneath the fuel filters, the catch pan having a surface contoured to drain any liquids falling into said catch pan to a collection point, and an opening at said collection point for draining liquids from said catch pan.

3. The fuel filter support structure of claim 2, further comprising a fuel catch tank disposed between and attached to said walls.

4. The fuel filter support structure of claim 3, further comprising a front plate joining said walls at a position distal from said base portion, said front plate adapted for mounting of an engine condition monitoring device.

5. The fuel filter support structure of claim 4, wherein said side walls are spaced sufficiently far apart so as to provide a space for fuel supply equipment mounted therein.

6. The fuel filter support structure of claim 5, wherein said spacing between said side walls decreases in a direction away from said base portion.

7. The fuel filter support structure of claim 6, wherein said means for mounting a plurality of fuel filters on each of said walls comprises brackets and a manifold fluidly connecting said fuel filters on one of said walls, to said fuel filters on the other one of said walls, in series flow.

8. A fuel filter support structure especially adapted for mounting in a confined area proximal an engine, comprising:
a base portion adapted to be mounted in a operative position with respect to said engine;
two spaced apart walls attached to the base portion and extending outwardly therefrom, said spacing between said side walls decreasing in a direction away from said base portion;
a front plate joining said walls at a position distal from said base portion, said front plate adapted for mounting of an engine condition monitoring device;
a means for mounting a plurality of fuel filters on each of said walls, with said fuel filters accessible from a position to either side of said walls;
a fuel overflow tank disposed between and attached to said walls; and
a catch pan positioned beneath the fuel filters, the catch pan having a surface contoured to drain any liquids falling into said catch pan to a central point, and an opening at said central point for draining liquids from said catch pan.

9. The fuel filter support structure of claim 8, further comprising fuel supply equipment mounted between said walls.

10. The fuel filter support structure of claim 8, wherein said means for mounting a plurality of fuel filters on each of said walls comprises brackets and a manifold fluidly connecting said fuel filters on one of said walls, to said fuel filters on the other one of said walls, in series flow.
